(19) United States
(12) Patent Application Publication
(10) Pub. No.: US 2006/0126329 A1
(43) Pub. Date: Jun. 15, 2006

(54) Light emitting diode indoor lamp

(76) Inventor: Kuan-Chih Fu, Tainan City (TW)

Correspondence Address: Kuan-Chih Fu, P.O. BOX 90, Tainan City, 70499, TW

(21) Appl. No.: 11/008,948

(22) Filed: Dec. 13, 2004

(51) Int. Cl. F21S 13/00

(52) U.S. Cl. 362/249

(57) ABSTRACT

A light emitting diode indoor lamp comprises a lamp seat having a positioning post at an inner wall thereof; a circuit board assembled into the lamp seat; the circuit board being installed with an insulating plate; an aluminum plate and a plurality of LED lamps; a backside of the circuit board being installed with conductive copper wires; and a lampshade combined to the lamp seat. The circuit board is an aluminum plate capable of being formed with a predetermined shape by punching so as to be used to an indoor lamp. The lamp seat is installed with a wire hole; and an inner wall of the lamp seat is installed with a plurality of hooks. A periphery of the lampshade is installed with buckles for coupling to the hooks of the lamp seat. The lamp seat is installed to the screwing portion. The lampshade is installed with screw holes.

### BACKGROUND OF THE INVENTION

1. Field of the Invention

The present invention relates to a light emitting diode indoor lamp, wherein a circuit board of the lamp is made of aluminum which has preferred extension ability, the circuit board can be punched into any desired shape so as to be used with indoor lamps of various shapes. The circuit board is formed integrally by punching so that the assembly work can be performed rapidly and easily.

2. Description of the Prior Art

Generally, indoor lamps are lamp seats assembled with bubbles or lamp tubes as indoor light sources. However the prior art lamps use tungsten as light source which are burnable in high temperature and consumed with a large amount of light. Thereby the light is strong so as to be harmful to eyes.

### SUMMARY OF THE INVENTION

Accordingly, the primary object of the present invention is to provide a light emitting diode indoor lamp, wherein a circuit board of the lamp is made of aluminum which has preferred extension, the circuit board can be punched into any desired shape so as to be used with indoor lamps of various shapes. The circuit board is formed integrally by punching so that the assembly work can be performed rapidly and easily.

To achieve above object, the present invention provides a light emitting diode indoor lamp comprises a lamp seat having a positioning post at an inner wall thereof; a circuit board assembled into the lamp seat; the circuit board being installed with an insulating plate; an aluminum plate and a plurality of LED lamps; a backside of the circuit board being installed with conductive copper wires; and a lampshade combined to the lamp seat. The circuit board is an aluminum plate capable of being formed with a predetermined shape by punching so as to be used to an indoor lamp. The lamp seat is installed with a wire hole; and an inner wall of the lamp seat is installed with a plurality of hooks. A periphery of the lampshade is installed with buckles for coupling to the hooks of the lamp seat. The lamp seat is installed to the screwing portion. The lampshade is installed with screw holes.

The various objects and advantages of the present invention will be more readily understood from the following detailed description when read in conjunction with the appended drawing.

### BRIEF DESCRIPTION OF DRAWINGS

FIG. 1 is the exploded perspective view of the present invention.

FIG. 2 is a cross sectional view about the circuit board of the present invention.

FIG. 3 is a perspective view of the present invention.

FIG. 4 is a schematic view about the application of the present invention.

FIG. 5 is a schematic view about another application of the present invention.

### DETAILED DESCRIPTION OF THE PREFERRED EMBODIMENT

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

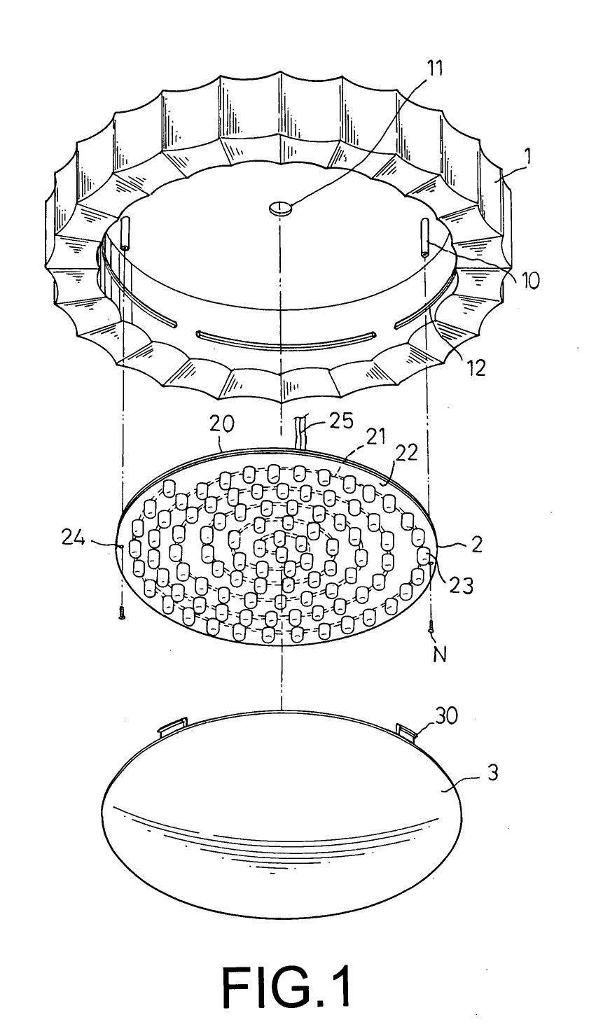

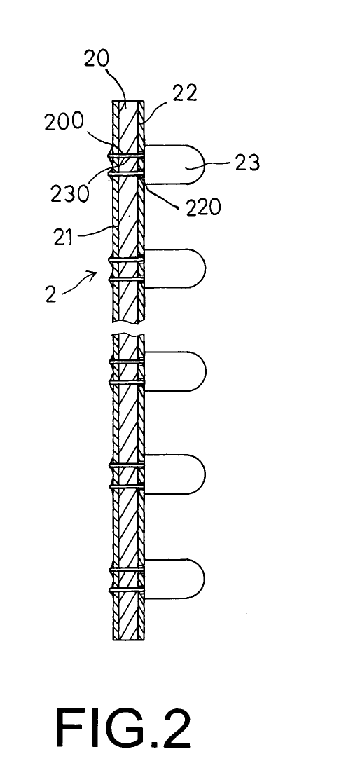

Referring to FIGS. 1 and 2, the present invention has the following elements.

A lamp seat 1 has a positioning post 10 at an inner wall thereof. The lamp seat 1 is installed with a wire hole 11. An inner wall of the wire hole 11 is installed with a hook 12.

A circuit board 2 is installed in the lamp seat 1. An insulating plate 20 an aluminum plate 22 and a plurality of LED (light emitting diode) lamps 23 are installed on the circuit board 2. A backside of the circuit board 2 is arranged with conductive copper wires 21. A plurality of inserting holes 200 are formed on the insulating plate 20. A plurality of via holes 220 are formed on the aluminum plate 22 corresponding to the inserting holes 200 of the insulating plate 20. The plurality of LED lamps 23 are assembled to the circuit board 2. Each LED lamp 23 has a leg 230 passing through the via hole 220 of the aluminum plate 22 and the inserting hole 200 of the insulating plate 20 so as to be welded to the copper wire 21. A plurality of through holes 24 are formed in the circuit board 2 so as to combined to the positioning posts 10 of the lamp seat 1. The circuit board 2 is connected to the electric wires 25. The electric wires 25 pass through the wire hole 11 of the lamp seat 1.

A lampshade 3 is combined to the lamp seat 1. A periphery of the lampshade 3 is installed with buckles 30 so as to be buckled to the hooks 12 of the lamp seat 1.

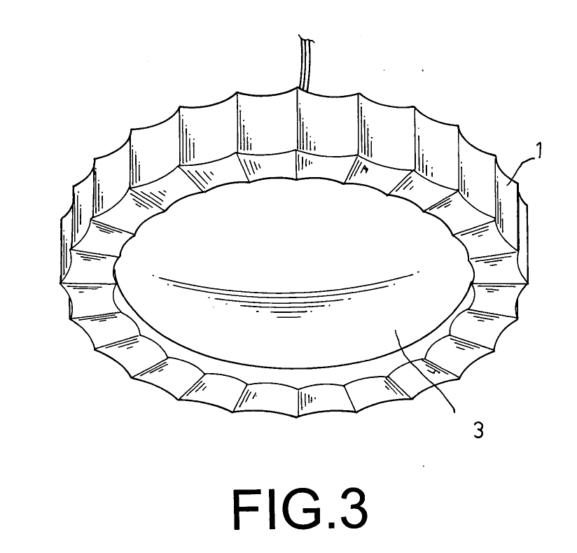

In assembly, see FIGS. 1 to 3, it is only necessary to assemble the circuit board 2 into the lamp seat 1. The through holes 24 of the circuit board 2 are coupled to the positioning posts 10 of the lamp seat 1. Then the buckles 30 of the lampshade 3 are buckled to the hooks 12 of the lamp seat 1. Thus the lampshade 3 covers upon and positions to the lamp seat 1.

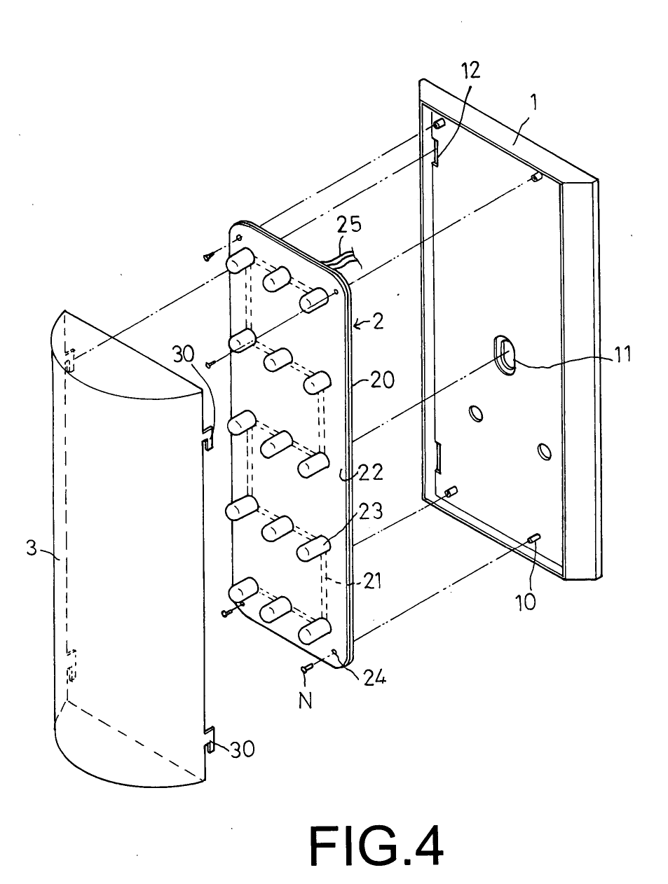

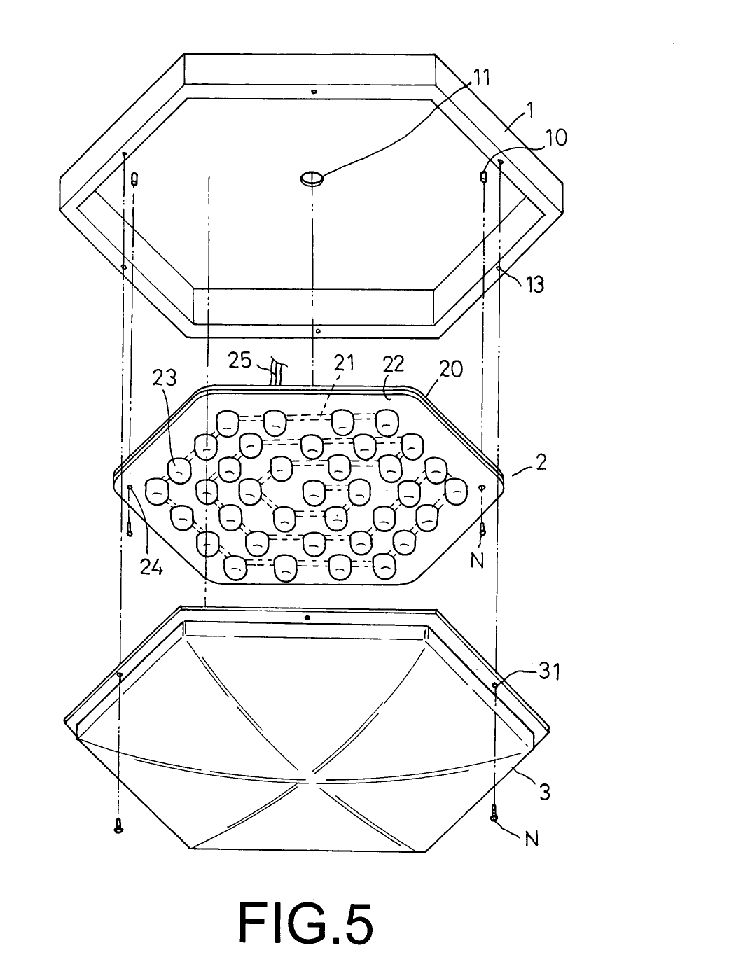

Furthermore, by the extension of aluminum material, the circuit board 2 can be punched to any desired shape (see FIGS. 4 and 5) so as to be used with lamps of various shapes.

Furthermore, as shown in FIG. 5, the lamp seat 1 is installed to the screwing portion 13. The lampshade 3 is installed with screw holes 31 for coupling to the screw portions 13 of by using screws N.

Advantages of the present invention will be described herein. Since aluminum has preferred extension ability, the circuit board can be punched into any desired shape so as to be used with indoor lamps of various shapes. Furthermore, the circuit board is formed integrally by punching so that the assembly work can be performed rapidly and easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A light emitting diode indoor lamp comprising:
a lamp seat having a positioning post at an inner wall thereof;
a circuit board assembled into the lamp seat; the circuit board being installed with an insulating plate; an aluminum plate and a plurality of LED lamps; a backside of the circuit board being installed with conductive copper wires; and
a lampshade combined to the lamp seat; and
wherein the circuit board is an aluminum plate capable of being formed with a predetermined shape by punching so as to be used with an indoor lamp.

2. The light emitting diode indoor lamp as claimed in claim 1, wherein the lamp seat is formed with a wire hole; and an inner wall of the lamp seat is formed with a plurality of hooks.

3. The light emitting diode indoor lamp as claimed in claim 2, wherein a periphery of the lampshade is installed with buckles for coupling to the hooks of the lamp seat.

4. The light emitting diode indoor lamp as claimed in claim 1, wherein the lamp seat is formed with a screwing portion; and the lampshade is formed with screw holes for coupling to the screw portions of by using screws.
